(19) United States
(12) Patent Application Publication
(10) Pub. No.: US 2019/0044393 A1
(43) Pub. Date: Feb. 7, 2019

(54) METHOD OF AUTHENTICATION

(71) Applicant: Apple Inc., Cupertino, CA (US)

(72) Inventor: Jeffrey Douglas Louis, Freemans Bay (NZ)

(21) Appl. No.: 16/143,314

(22) Filed: Sep. 26, 2018

Related U.S. Application Data
(63) Continuation of application No. PCT/NZ2017/050033, filed on Mar. 27, 2017.
(60) Provisional application No. 62/316,819, filed on Apr. 1, 2016.
(60) Provisional application No. 62/437,334, filed on Dec. 21, 2016.

(51) Int. Cl. H02J 50/80; H02J 50/10; H04B 5/00

(52) U.S. Cl. CPC H02J 50/80; H02J 50/10; H02J 7/025; H04B 5/0075; H04B 5/0037

(57) ABSTRACT

A method comprising locating an inductive power receiver in a charging zone of an inductive power transmitter sending a transmitter identifier to the receiver; sending the transmitter identifier to a remote server; the remote server verifying 5 the transmitter identifier and sending an authentication token to the wireless power transmitter; and the transmitter verifying the authentication token and enabling inductive power transfer to the receiver.

### FIELD

This invention relates to a method of authentication. More specifically, but not solely, one or more embodiments may relate to a method of authentication for a public wireless charging system.

### BACKGROUND

Electrical converters are found in many different types of electrical systems. Generally speaking, a converter converts a supply of a first type to an output of a second type. Such conversion can include DC-DC, AC-AC, and DC-AC and AC-DC electrical conversions. In some configurations a converter may have any number of DC and AC ‘parts’, for example a DC-DC converter might incorporate an AC-AC converter stage in the form of a transformer.

One example of the use of converters is in inductive power transfer (IPT) systems. IPT systems will typically include an inductive power transmitter and an inductive power receiver. The inductive power transmitter includes a transmitting coil or coils, which are driven by a suitable transmitting circuit to generate an alternating magnetic field. The alternating magnetic field will induce a current in a receiving coil or coils of the inductive power receiver. The received power may then be used to charge a battery, or power a device or some other load associated with the inductive power receiver. Further, the transmitting coil and/or the receiving coil may be connected to a resonant capacitor to create a resonant circuit. A resonant circuit may increase power throughput and efficiency at the corresponding resonant frequency.

Some IPT systems use a backscatter communications channel or some other form of IPT-reliant communication to allow an inductive power receiver to communicate load requirements to the primary side (i.e., the inductive power transmitter). For example, changes to the magnitude of the transmitting coil signal, its phase and/or its frequency may be requested by an inductive power receiver in order to correspond with the load requirements of that inductive power receiver. This is known as primary side regulation. The Qi standard by the Wireless Power Consortium (WPC) is an example primary side regulation that uses IPT-reliant communication to provide a channel of communication.

A drawback to IPT-reliant communication is that power transfer needs to begin (even if at a reduced rate) to enable communication and therefore power may be transferred to an invalid receiver.

### SUMMARY

It is an object of the invention to provide a method of authentication for an inductive power transfer system or to at least provide the public with a useful choice.

According to one example embodiment there is provided an inductive power receiver comprising:
a power receiving coil; and
communications circuitry operatively connected to the power receiving coil and configured:
   to receive a transmitter identifier from an inductive power transmitter,
   to send the transmitter identifier to a remote server,
   responsive to the remote server verifying the transmitter identifier, to receive an authentication token from the remote server, and
   to send the authentication token to the transmitter,

wherein responsive to the transmitter verifying the authentication token, the power receiving coil is configured to receive wireless power from the transmitter.

According to a second example embodiment there is provided a method comprising:
locating an inductive power receiver in a charging zone of an inductive power transmitter;
sending a transmitter identifier to the receiver;
sending the transmitter identifier to a remote server;
the remote server verifying the transmitter identifier and sending an authentication token to the wireless power transmitter; and
the transmitter verifying the authentication token and enabling inductive power transfer to the receiver.

The transmitter may only require a power connection. The transmitter may not be connected to the internet.

The receiver may communicate with the remote server using the mobile app or the website.

The method may comprise the step of limiting the initial inductive power transfer level until the authentication token has been verified.

According to a third example embodiment there is provided a mobile device comprising:
an inductive power receiver configured to charge the mobile device;
a first communication channel configured to receive a transmitter identifier from an inductive power transmitter; and
a second communication channel configured to send the transmitter identifier to a remote server.

According to a forth example embodiment there is provided a charging station comprising:
an inductive power transmitter configured to charge a mobile device;
a communication channel configured to send a transmitter identifier to an inductive power receiver, receive an authentication token from the receiver, and if the token is valid, to enable inductive power transfer to the receiver.

According to a fifth example embodiment there is provided an inductive power receiver configured to:
request charging from an inductive power transmitter or receive an invitation for charging from the transmitter;
receive a transmitter identifier;
send the transmitter identifier to a remote server;
receive an authentication token from the remote server and send it to the transmitter.

The communication between the transmitter and the receiver may be by an in-band inductive/backscatter channel. For example, communication may be by load or amplitude modulation of the power transfer signal, or frequency modulation of the power transfer signal.

The transmitter identifier and the authentication token may be passed between a communications unit associated with the in-band channel and a WAN communications unit for communicating with the remote server.

The request may be for a higher power transfer rate than the current power transfer rate.

The transmitter may initially supply a lower power transfer rate than requested. The transmitter may subsequently send the transmitter identifier as part of an authentication challenge.

The transmitter identifier may be associated with the transmitter's location

According to a sixth example embodiment there is provided an inductive power transmitter configured to:
receive a request for charging from an inductive power receiver or send an invitation for charging to the receiver;
send a transmitter identifier to the receiver;
receive an authentication token from the receiver and verify against a stored key; and
enable inductive power transfer to the receiver in response to verifying the token.

The request may be for authentication in order to increase the power transfer level.

Verifying the authentication token may enable an increased inductive power transfer rate to the receiver.

The communication between transmitter and receiver may be by an in-band inductive/backscatter channel.

Wherein the transmitter identifier may be associated with transmitter location information.

According to a seventh example embodiment there is provided a remote server configured to:
receive a transmitter identifier from an inductive power receiver;
generate an authentication token using a key associated with the transmitter identifier;
send the authentication token to the receiver.

The authentication token may be sent together with a timestamp or expiry time.

The transmitter identifier may be used to associate information about an inductive power transmitter with the receiver.

The associated information may include transmitter location information

According to an eighth example embodiment there is provided a method of communicating transmitter data between an inductive power transmitter and a remote server comprising: communicating transmitter data between the transmitter and an inductive power receiver; and communicating transmitter data between the inductive power receiver and the remote server.

The transmitter data may include transmitter software, such as firmware updates, configuration software, provisioning software, and maintenance software firmware and/or software updates for the transmitter data. The transmitter software may be sent from the remote server to the receiver, and then sent from the receiver to the transmitter.

The communications between the transmitter and the receiver may use a modulated magnetic field channel distinct from the inductive power transfer. The modulated magnetic field channel may be a near-field communications channel or Bluetooth®.

The receiver may be associated with a mobile device able to communicate with the remote server.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a schematic diagram of an inductive power transfer system;

FIG. 2 is a flow diagram for an authentication method for an inductive power transfer system;

FIG. 3 is a block diagram of the devices involved in an authentication method according to an example embodiment;

FIG. 4 is a block diagram of a mobile device according to one embodiment;

FIG. 5 is a block diagram of a charging station according to one embodiment;

FIG. 6 is a block diagram of the devices involved in an authentication method according to another example embodiment; and

FIG. 7 is a flow diagram for a further embodiment of a method of communicating transmitter data.

### DETAILED DESCRIPTION

Mobile devices, such as smartphones, tablets, laptops and smartwatches, and other internet connected devices are often battery powered. As such, these devices require charging, and the battery may need to be recharged when the user is away from home. Public charging stations are a useful solution. These wireless charging stations could comply with wireless charging standards such as Qi Wireless Charging to ensure compatibility. Possible locations for public wireless charging stations include public transport, cafes, restaurants, airports, libraries and other suitable public locations.

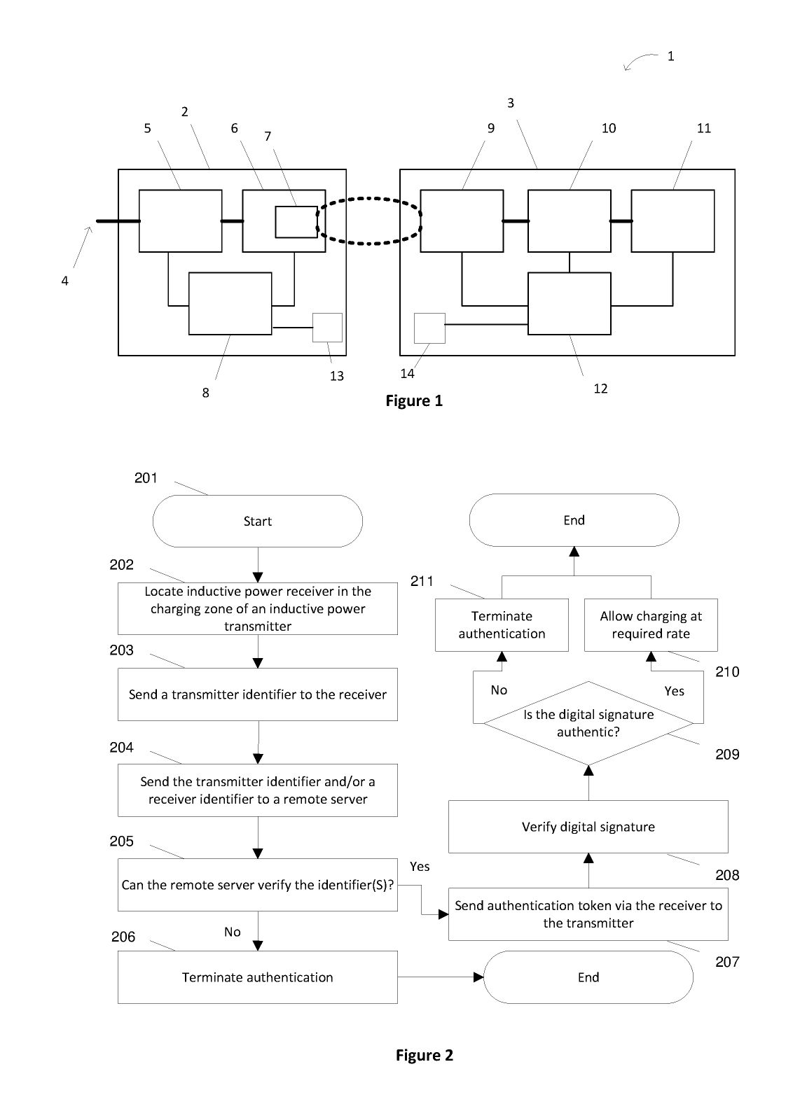

An inductive power transfer (IPT) system 1 is shown generally in FIG. 1. The IPT system includes an inductive power transmitter 2 and an inductive power receiver 3. The inductive power transmitter 2 is connected to an appropriate power supply 4 (such as mains power or a battery). The inductive power transmitter 2 may include transmitter circuitry having one or more of a converter 5, e.g., an AC-DC converter (depending on the type of power supply used) and an inverter 6, e.g., connected to the converter 5 (if present). The inverter 6 supplies a transmitting coil or coils 7 with an AC signal so that the transmitting coil or coils 7 generate an alternating magnetic field. In some configurations, the transmitting coil(s) 7 may also be considered to be separate from the inverter 5. The transmitting coil or coils 7 may be connected to capacitors (not shown) either in parallel or series to create a resonant circuit.

A controller 8 may be connected to each part of the inductive power transmitter 2. The controller 8 may be adapted to receive inputs from each part of the inductive power transmitter 2 and produce outputs that control the operation of each part. The controller 8 may be implemented as a single unit or separate units, configured to control various aspects of the inductive power transmitter 2 depending on its capabilities, including for example: power flow, tuning, selectively energising transmitting coils, inductive power receiver detection and/or communications. There may also be a separate transmitter communications module 13. In FIG. 1 the transmitter communications module 13 is represented as integral to the transmitter 2 and connected to the controller 8. However, it will be appreciated that in some instances the transmitter communications module 13 may also be considered distinct from the transmitter 2 but connected to the controller 8. The transmitter communications module 13 may be configured to communicate using a modulated magnetic field communications channel. For example, the transmitter communications module 13 may be a near field communications (NFC) module able to communicate with other NFC-enabled devices using suitable NFC channels or may use Bluetooth®, Bluetooth low energy (BLE), ZigBee®, WiFi or other similar protocols.

The inductive power receiver 3 includes a receiving coil or coils 9 connected to receiver circuitry which may include power conditioning circuitry 10 that in turn supplies power to a load 11. When the coils of the inductive power transmitter 2 and the inductive power receiver 3 are suitably coupled, the alternating magnetic field generated by the transmitting coil or coils 7 induces an alternating current in the receiving coil or coils 9. The power conditioning circuitry 10 is configured to convert the induced current into a form that is appropriate for the load 11, and may include for example a power rectifier, a power regulation circuit, or a combination of both. The receiving coil or coils 9 may be connected to capacitors (not shown) either in parallel or series to create a resonant circuit. In some inductive power receivers, the receiver 3 may include a controller 12 which may control tuning of the receiving coil or coils 9, operation of the power conditioning circuitry 10 and/or communications. There may also be a separate receiver communications module 14. In FIG. 1 the receiver communications module 14 is represented as integral to the receiver 3 and connected to the controller 8. However, it will be appreciated that in some instances it may be more accurate to consider the receiver communications module 14 as distinct from the receiver 3. For example, where the inductive power receiver 3 and the receiver communications module 14 are two distinct modules inside a mobile device. The receiver communications module 14 may be configured to communicate using a modulated magnetic field communications channel. Such modulated magnetic field communications may have a relatively short effective range. For example, the receiver communications module 14 may be a near field communications (NFC) module able to communicate with other NFC-enabled devices using suitable NFC channels, or may use Bluetooth®, Bluetooth low energy (BLE), ZigBee®, WiFi or other similar protocols. For example, as will be described in more detail below, the receiver communications module 14 may communicate with the transmitter communications module described above.

It is understood that the use of the word “coil” herein is meant to designate structures in which electrically conductive wire is wound into three dimensional (coil) shapes or two dimensional planar (coil) shapes, electrically conductive material fabricated using printed circuit board (PCB) techniques into three dimensional coil shapes over plural PCB ‘layers’, and other coil-like shapes.

Messages from the inductive power receiver 3 to the inductive power transmitter 2 can be sent using a communications channel that relies on power transfer between the transmitting coil(s) 7 and the receiving coil(s) 9 (such as backscatter communications). For the sake of clarity, this type of communication will be referred to herein as “IPT-reliant communication”. In an example embodiment the voltage across and the current through the receiving coil or coils 9 is amplitude modulated by, or under control of, the controller 12 or a communications module, in accordance with a data stream. This modulation is then observed as voltage or current amplitude variation in transmitting coil or coils 7 and can be demodulated by the inductive power transmitter 2, so that the original data stream can be recovered. The inductive power transmitter 2 may send messages to the inductive power receiver 3 in the same way. Among other uses, this backscatter communications channel can be used to enable primary side regulation without the need for dedicated radio transceivers. Primary side regulation mediated by a backscatter communications channel is sometimes necessary in order to meet wireless power interoperability standards. Primary side regulation can be very efficient because a significant source of loss in any IPT system 1 is due to losses in the transmitting coil or coils 7 and the receiving coil or coils 9 and primary side regulation can allow these losses to be minimized.

In another embodiment, messages from the inductive power receiver 3 to the inductive power transmitter 2 can be sent using the modulated magnetic field communications channel associated with the communications modules 13, 14. The inductive power transmitter 2 may send messages to the inductive power receiver 3 in the same way. In this way, the modulated magnetic field communications channel may be distinct from inductive power transfer (i.e., not IPT-reliant communication) and can be used to communicate data between the transmitter and the receiver.

The modulated magnetic field communications described above may have a relatively short effective range (for example, NFC has an effective range in the order of 200 mm and backscatter communications are limited to the range of the power transfer signal). This means that the transmitter is limited to communicating with receiver(s) that are located relatively proximate to the transmitter.

Conversely, communication means with a longer range (such as Bluetooth or WiFi) may (in addition to allowing communication with a nearby power receiver) allow a transmitter to communicate with receiver(s) that are located remotely from the transmitter or with a plurality of receivers simultaneously. Multiple devices could be located and charged simultaneously on an array type transmitter pad. An additional mechanism may determine which receiver(s) are located proximate to specific transmitter coils, and therefore which coil in the array to energise.

As described in further detail below, the present technology contemplates the gathering and use of transmitter and/or receiver identifiers to facilitate wireless charging. For example, a transmitter may use a receiver's identifier to authorize the receiver as a valid receiver to receive power wirelessly. The communication of this information can occur over IPT-reliant communication channels (such as a FSK or ASK), as well as so-called out of band communication channels such as NFC and/or Bluetooth. These communication channels can also facilitate feedback control of how much power a transmitter should send to a receiver.

The present disclosure recognizes that communications channels can be used to transmit other kinds of information. For example, a wireless power receiver that is equipped with a cellular connection can download a firmware update and send that firmware update to a wireless power transmitter that otherwise would could not have downloaded the update. It is also possible that some implementers of the present technology could choose to send other types of data, such as usage metrics about a wireless power receiver.

Entities that collect, analyse, transfer, store, or otherwise use information data that owners of wireless power receivers (e.g., cellular phones) might perceive to be sensitive or personal should implement and consistently use privacy policies and practices that are generally recognized as meeting or exceeding industry or governmental standards for maintaining data securely and privately. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In addition, the present technology may be implemented in ways where users can selectively block the use of, or access to, sensitive information data. For example, systems implementing the present technology can allow users to opt-in, or opt-out of participation. Additionally, the present technology may be implemented such that users are informed of possible data transfers or otherwise be reminded as they use a public wireless charger and be given an opportunity to decline usage before any data sensitive data transfer.

Information can also be handled in a way to minimize risks of unintentional or unauthorized use. For example, while it may be useful for an operator of public chargers to understand when the charging devices are being most heavily used (e.g., so that more could be installed), such metrics could be obtained in such a way that anonymizes who or what power receiver devices are involved so as to maintain user privacy.

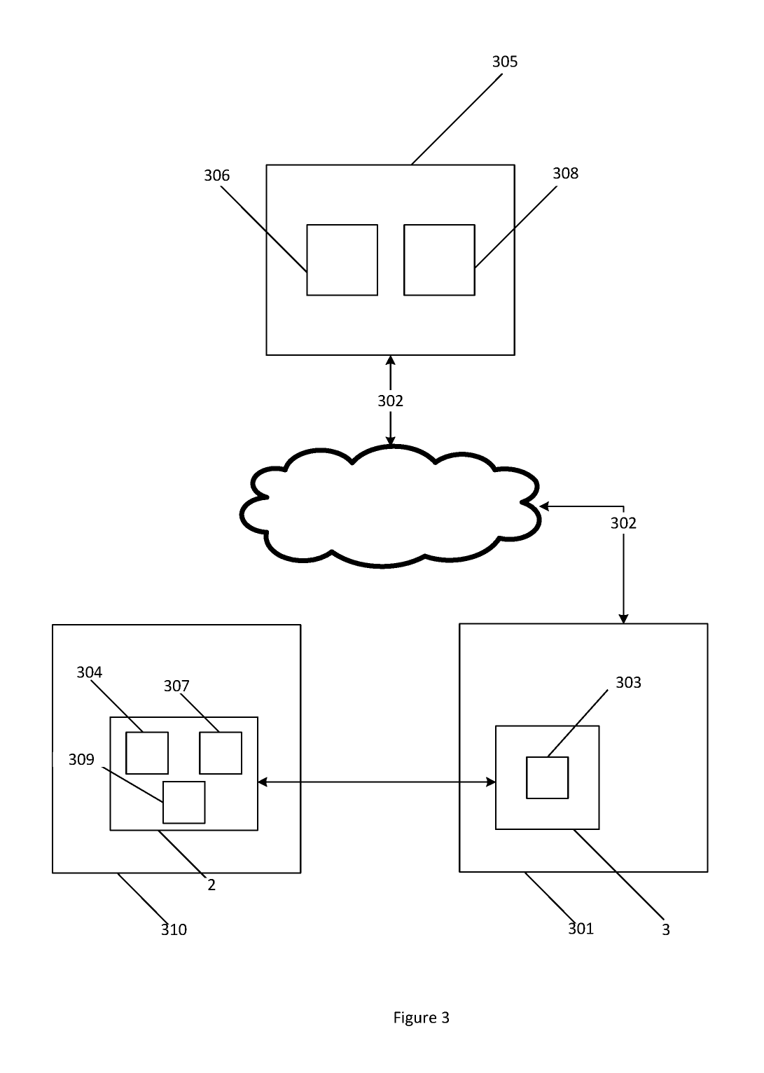

FIG. 2 shows a method 200 of authentication of an inductive power receiver 3 to an inductive power transmitter 2, which may be used with the inductive power transfer system 1 shown in FIG. 1. An example system configuration is shown in FIG. 3. The inductive power receiver 3 is connected to a mobile device 301, which has a data connection 302. The inductive power transmitter is provided within a charging station 310.

The method 200 in FIG. 2 includes:
Initially, in step 201, a transmitter identifier 304 for an inductive power transmitter 2 is determined.
In step 202, the inductive power receiver 3 is placed in the charging zone of the inductive power transmitter 2.
In step 203, the transmitter 2 sends the transmitter identifier 304 to the receiver 3. If the transmitter 2 is enabled with IPT-reliant communications then the transmitter begins transmitting power to the receiver 3 at a low rate, which initiates communication between the transmitter 2 and the receiver 3 allowing the transmitter identifier 304 to be sent to the receiver 3 according to the particular type of IPT-reliant communication. As an alternative to IPT-reliant communication, the transmitter 2 may use the transmitter communications module 13 to send the transmitter identifier 304 to the receiver communications module 14 using a modulated magnetic field channel (such as NFC, Bluetooth, so forth). Since the communication modules 13 14 use a channel distinct from inductive power transfer, it is not necessary for the transmitter 2 to begin transmitting power to the receiver 3.
In step 204, the mobile device 301 sends the transmitter identifier 304 over the data connection 302 to the remote server 305.
In step 205, the remote server 305 attempts to verify the transmitter identifier 304 by comparison with the stored values in its database.
If the result is “NO”, then in step 206 the authentication method is terminated, with the transmitter 2 notified by a message sent via the receiver 3, or alternatively by the lack of a response from the receiver 3 within a pre-determined time-out expiry time. The method is ended.
If the result is “YES”, then in step 207, the remote server 305 produces an authentication token containing a cryptographic digital signature and sends it over the data connection 302 to the receiver 3. The receiver 3 sends the authentication token to the transmitter 2. The receiver 3 sends the authentication token using the same communications protocol as was used in relation to step 203. For example, using IPT-reliant communications or NFC.
In step 208, the transmitter 2 verifies the authentication token by verifying the digital signature against a message and a cryptographic public key.
In step 209, the authenticity of the digital signature is checked.
If the result is “YES”, then in step 210 the transmitter 2 enables charging at the required rate and completes the authentication method.
If the result is “NO”, then in step 211, the authentication method is terminated, and this result is communicated to the receiver 3, or alternatively by the lack of the response from the receiver 3 within a pre-determined time-out expiry time.

The mobile device 301 connected to the receiver 3 and receiving wireless power may be any suitable battery powered device that has a data communication connection 302. The data communication connection 302 may be any suitable communication connection that enables the mobile device to communicate with the remote server 305. For example, the data communication connection may be TCP/IP, SMS, interactive voice or another suitable wide area connection. It will be appreciated that the mobile device may use a suitable network communication module to communicate with the remote server using the data communication connection 302 (via a wireless and/or wired wide area network). Preferably the mobile device will use a wireless network communication module (such as a Wi-Fi module or cellular data module) for the data communication connection 302.

The charging station 310 connected to the transmitter 2 may be a flat pad or integrated into a table at the public location. It may also be a bin into which a multitude of devices may be placed, or may contain individual compartments that are lockable for security, for example a pin keypad. The charging zone of a particular charging station is determined by application requirements. Some transmitters 2 may have a wider range and so the size of the charging zone is therefore increased. The charging station may be configured so that the device can be freely placed in two or three dimensions. The charging station may be linked to a display that notifies a user when their device is fully charged such as a large LCD display mounted on the internal wall of the location providing public wireless charging. In this way a user could securely lock their phone in the charging station, and the display could indicate to them when to collect their phone. Alternatively, the mobile app or the charging station could give an estimate of the time to full charge once charging begins.

The transmitter may be identified using transmitter identifier information. For example, a transmitter identifier may be determined in accordance with step 201. The transmitter identifier 304 may be unique to the transmitter 2 and the transmitter identifier information may include information about where the transmitter is located and a timestamp. The transmitter identifier may be static or periodically generated by the transmitter (e.g. if the transmitter identifier includes a timestamp). The transmitter identifier 304 may be stored on a memory associated with the transmitter 2. Alternatively, the transmitter identifier 304 may be generated in response to a receiver 3 requesting charging. For example, referring to FIG. 2, there may be an intermediary step (not shown) between step 202 and step 203, whereby the receiver 3 sends a charging request to the transmitter 2. The receiver 3 sends the charging request using the same communications protocol as used in relation to step 203. Upon receipt of the charging request, the transmitter 2 generates the transmitter identifier 304. Alternatively, the transmitter 2 may retrieve the transmitter identifier 304 if stored on a memory associated with the transmitter 2. The method then proceeds with step 204.

Referring again to step 202, the inductive power receiver 3 is placed in the charging zone of the inductive power transmitter 2. In order for the remaining steps of the method to occur, it is necessary for the system to determine that the receiver is located in the charging zone of the transmitter 2. The transmitter may detect the presence of a receiver and/or its location within the charging zone.

In one particular embodiment, the transmitter communications module 13 may detect the receiver communications module 14. For example, in embodiments where the transmitter communications module 13 is adapted for NFC, the transmitter communications module may periodically or constantly poll to detect the presence of a suitable receiver communications module 14. The benefit of this approach is that the method will only proceed beyond this step provided a valid receiver 3 is proximate to the transmitter 2. Another benefit of using the transmitter communications module 13, which is distinct from power transfer, is that power does not need to be supplied to the transmitting coil(s) 7 (as is the case with IPT-reliant communications), limiting the possibility that power will be transferred to an invalid device. Finally, NFC has relatively low power consumption, thereby decreasing the power consumption of the charging station when in standby.

In another embodiment, the receiver communications module 14 may detect the transmitter communications module 13. For example, in embodiments where the receiver communications module 14 is adapted for NFC, the receiver communications module may periodically or constantly poll to detect the presence of a suitable transmitter communications module 13. Since constant or periodic polling can drain device battery, it may be preferable for the receiver communications module 14 to begin polling upon a certain user input. For example, the receiver communications module 14 may be instructed to commence polling upon a mobile app or web page being opened by a user on the mobile device 301. A benefit to this approach is that the transmitter communications module 13 may be completely passive, thereby further decreasing the power consumption of the charging station when in standby.

Similarly, with Bluetooth® the receiver communications module may periodically poll to detect the presence of a suitable transmitter communications module 13 or to commence polling upon a mobile app or web page being opened by a user on the mobile device 301.

Referring again to step 204, after the receiver 3 has received the transmitter identifier 304 from the transmitter 2 (step 203), the transmitter identifier 304 is then provided to the mobile device 301 via the receiver 3. The mobile device 301 sends the transmitter identifier 304 to the remote server 305. As will be described later, the mobile device may communicate via a web page or a mobile app on the mobile device.

In one embodiment, the mobile device 301 sends the transmitter identifier 304 to the remote server. Upon receiving the transmitter identifier, the remote server 305 verifies the transmitter identifier 304. The remote server may include a database of permitted transmitter identifiers and the remote server 305 verifies the transmitter identifier if it corresponds to a transmitter identifier in the data base.

If verification is not successful, the remote server 305 may send an error message to the mobile device 301 by the data communication connection 302.

Upon verification, the remote server generates an authentication token (as described in more detail below) that is sent to the mobile device 301 by the data communication connection 302. In one embodiment, the authentication token is received by the mobile app on the mobile device. Once received by the mobile device, the authentication token is sent to the transmitter 2 via the receiver 3 using one of the communication protocols previously described.

According to one embodiment, the authentication token includes a timestamp with the message from a real time clock (RTC) 306 at the remote server 305 and is only valid for a certain time period. To enforce this, the transmitter also has a RTC 307.

The digital signature may be created using an encryption method. The encryption will be described with reference to public key cryptography, however other suitable encryption methods may be used according to the requirements of the application. In the case where public key cryptography is used, the remote server has a private key 308. This is used to hash a message to create a digital signature. The transmitter 2 is able to verify the authentication token, as it has a public key 309. The public key 309, message and digital signature are used in a signature verifying algorithm to determine the validity of the digital signature. If the digital signature is as expected by the transmitter 2, then the authentication has been successful. The RSA or DSA methods as presented in FIPS186-4 may be used for the digital signature method, or alternatively a suitable proprietary method.

The encryption chosen may depend on the security concerns of the provider or a particular environment that the charging station will be present in. The messages from the transmitter 2 will be referred to as the “challenge” and those from the receiver 3 will be referred to as the “response”.

In some examples, the challenge message and private key 308 are used to create the digital signature. If additional information, such as the length of the permitted charging time, is present in the communication, then the digital signature is preferably computed using the private key 308 from the combination of the challenge message and the additional information.

In a first approach, the transmitter 2 enables full charging access when it receives a response (including the authentication token) from the receiver 3 containing an unlock code, which may be plaintext or an encrypted digital signature to be verified, from the remote server 305. Charging also cannot be stopped until the user removes their device from the charging station.

A solution with improved security is provided in a second approach. The transmitter 2 sends in its challenge its RTC 307 value. The remote server 305 then determines an appropriate response RTC 306 value. The transmitter 2 enables full charging access when it receives a response from the receiver 3 containing a valid digital signature and date and time RTC 306 value from the remote server 305. This notifies the transmitter 2 of the time at which the receiver 3 is no longer eligible to receive charging access. The response can be verified as authentic using the digital signature, or it may be ciphered by the remote server 305. However, this embodiment also has some vulnerabilities if the RTC 307 becomes corrupted. Closely spaced RTC values may also allow for discovery of the private key 308, as the text will be known to be similar.

A third approach has similar time limits, however the date and time RTC 307 value is optional in the message. The challenge message would contain a unique pseudo-random number sequence and optionally its RTC 307 value if it is requesting a clock value. The response message then contains the concatenated content of the challenge and response messages in message digest form. This improves protection from replay attacks and discovery of the private key 308 due to the pseudo-random number sequence. However, the strength of the system relies on the complexity and randomness of the challenge messages. This can be improved by applying one or more techniques, such as IETF RFC6979, NIST FIPS186-4 and DSA. This may increase the computational complexity.

Once the user has begun charging, the RTC 307 may be used to enforce whether the authentication remains valid. When each authentication is tied to a particular timestamp, it may only be used once. The allowed time period may be included in the returned communication from the remote server 305 or it may be defined in the communication protocol. This time period may relate to a suitable time period to charge an average device. The device 301 may be able to automatically re-authenticate to the same transmitter 2, or alternatively may not be able to, to prevent a user from monopolising a transmitter 2.

When pseudo-random numbers are used as the plaintext rather than a timestamp, no RTC 307 is required at the transmitter 2 or the remote server 305. This embodiment may utilise a timer to restrict the allowed access to the charging station 310, which may have the allowable time period defined in the communication protocol.

The transmitter 2 and the receiver 3 may communicate using IPT-reliant communications, such as the Qi Wireless Charging protocol or another suitable wireless charging standard. The communications may occur within the data exchange of the protocol, for example using the backscatter modulation communication and frequency or amplitude shift keying defined by Qi. The initial low rate of charging allows this type of communication to occur without allowing significant charging of the device. However, initial power transfer under an IPT-reliant communication approach can mislead a user into believing that their mobile device has commenced charging (for example, their mobile device may indicate charging as a result of such initial power transfer). The user may then leave their mobile device, only for the authentication method to fail without their knowledge and the mobile device will remain uncharged.

Alternatively, an additional communication channel decoupled and unrelated (i.e. not IPT-reliant communications) to the power transmission, such as NFC, Bluetooth, infrared or Wi-Fi, may be used. Preferably, the distinct communication channel may use a modulated magnetic field (as is the case with NFC). An alternative method may use the display screen and camera of the mobile device, if present, for communication. Barcodes or QR codes may be generated, and communication may occur when the charging station has a corresponding screen and camera. The communication may be used to determine a charging rate, for example if the mobile device's battery is full, then the transmitter 2 may be disabled or switch to a lower charging rate.

The Qi protocol provides for this bidirectional communication capability using proprietary data packets in Extended Power Profile. Legacy products operating using Baseline Power Profile or V1.1 of Qi would be required to communicate using an out of band channel.

The remote server 305 may be secured by a system such as a firewall. It requires access to gateways enabling the data connection 302 to connect with the receiver 3. This may be using TCP/IP, SMS, interactive voice or another appropriate wide area connection. Additionally, consistent with best practices for security keys, the private key 308 should be stored securely and the digital signatures should also be computed in a secure way.

The data connection 302 may be provided by the mobile device 1. It may include data packets routed using a GPRS connection to the internet, SMS messages, or a WiFi connection to the internet. The data connection 302 itself may be encrypted using SSL or may use a SSL or IPSec virtual private network (VPN) connection to the remote server 305.

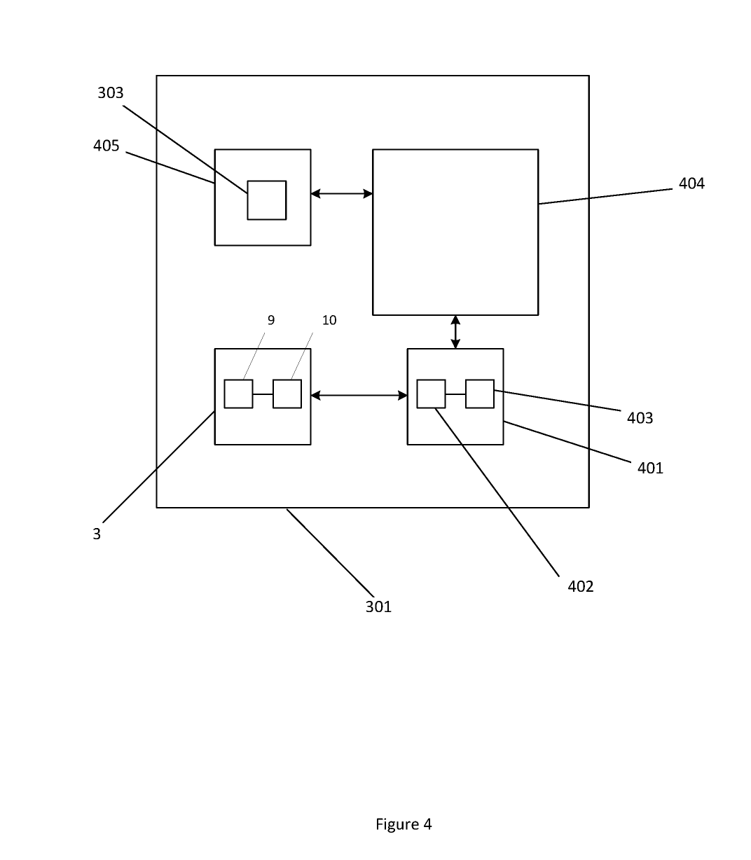

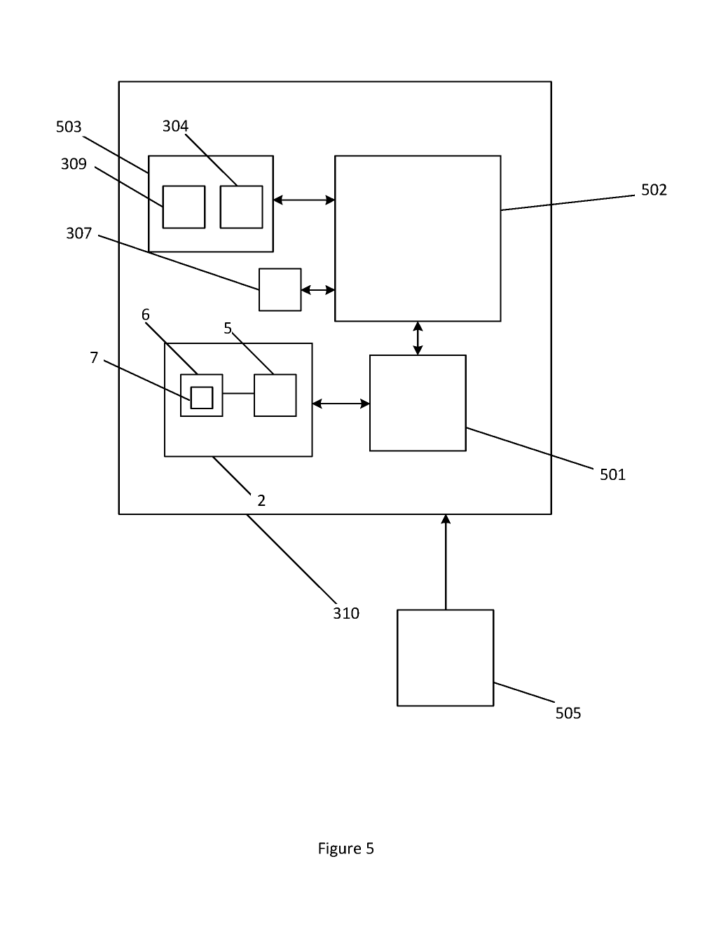

The configuration of the mobile device 301 is shown in FIG. 4. The receiver 3 comprises a coil or coils 9 and power conditioning circuitry 10. In addition to the receiver 3, there is also receiver control circuitry 401, comprising communication channel 402 and a Qi or similar chip 403. The mobile device also has a processor 404 and memory 405. The communication channel 402 may be an I²C bus, although any suitable means for communicating with the processor 404 during the authentication process may be used. The communication channel 402 may allow the Qi chip 403 to communicate with the processor 404 so that the communications between the transmitter 2 and receiver 3 may be accessed. This facilitates the authentication with the remote server 305. In a typical Qi charging system, there is limited communication between the processor and the Qi chip. Typically, the processor may be able to detect that wireless charging is occurring, however the communication is otherwise unavailable. The use of I²C enables further communication between the processor and the Qi chip, for the authentication method.

An example Qi chip which has I²C is IDT P9028AC, supporting the communication of Vrect, Iout and switching frequency values. Currently, there is no standard protocol for applying a communication channel. Some currently available chips may use SPI or a proprietary communication channel. A software API could also be chosen according to the application requirements. It may be desirable for a standard software API to be employed between the host processor platform and the communication channel between the transmitter 2 and receiver 3.

The hardware at the charging station 310 is shown in FIG. 5 and comprises a coil or coils 7, a converter 5 and an inverter 6. A Qi or similar chip 501 may be used to control the wireless power transfer. The transmitter 2 additionally has a processor 502, memory 503, and a real time clock 307. The apparatus may be referred to as a charging station 310. A data connection is not required at the charging station 310, it is simply required to be plugged into mains electricity 505, as all connectivity to the remote server is provided by the mobile device. The decryption function may be provided using the memory 503 and processor 502, or an integrated solution such as a hardware security module (HSM) may be used (not shown). The Qi chip 501 is configured so that the initial low power phase of step 203 is allowed using a limited Qi power contract, as well as allowing the authentication communications to occur and allowing or denying access to a full function Qi power contract.

The transmitter 2 may be incorporated into a charging station 310 having several transmitters. The same public key may be used for several transmitters 2, however individual public keys 309 may improve robustness against potential attackers deducing the private key 308. The transmitters 2 can communicate their own identifiers so that the remote server 305 knows where a given charging request is originating from. It may be preferable for the transmitter 2 to provide a digital signature attached to the message containing the transmitter identifier 304. The key to create the digital signature must then be kept secret inside the transmitter 2.

The authentication process may occur several times while the mobile device is at the charging station. This may be due to time limits defined in the protocol or communicated by timestamps. This would allow the remote server 305 to revoke access to a particular transmitter 2 if required.

There may also be a user interface (not shown) associated with the mobile device 301. The user interface may be a mobile app or a web page. When a user attempts to use a charging station, they may be prompted to download or view additional instructions.

In some examples this process includes a mobile app (web pages are also possible). The mobile app monitors the wireless power receiver module and responds to the message (including the transmitter identifier) received at the beginning of the authentication method from the transmitter 2. The message is sent to the remote server 305. The response from the remote server 305 is received by the mobile app and passed back to the receiver 3 to send to the transmitter 2.

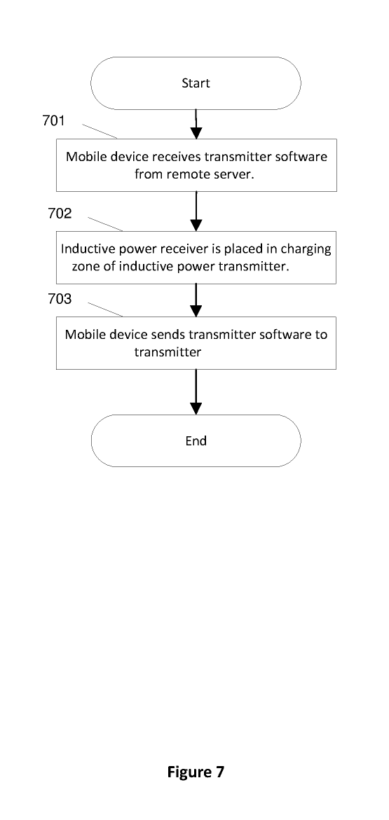

FIG. 7 shows a method 800 of communicating transmitter data from an inductive power receiver 3 to the inductive power transmitter 2, which may be used with the inductive power transfer system 1 shown in FIG. 1.

The method 800 in FIG. 7 includes:
Initially, in step 701, the mobile device 301 receives transmitter software from the remote server. In a particular embodiment, the transmitter software may be sent to a diagnostic app loaded on the mobile device 301. Such transmitter software may include firmware or software updates.
In step 702, the inductive power receiver 3 is placed in the charging zone of the inductive power transmitter 2.
In step 703, the mobile device 301 sends the transmitter software to the transmitter 2 via the receiver 3, using either an IPT-reliant or not IPT-reliant communications protocol as previously described.

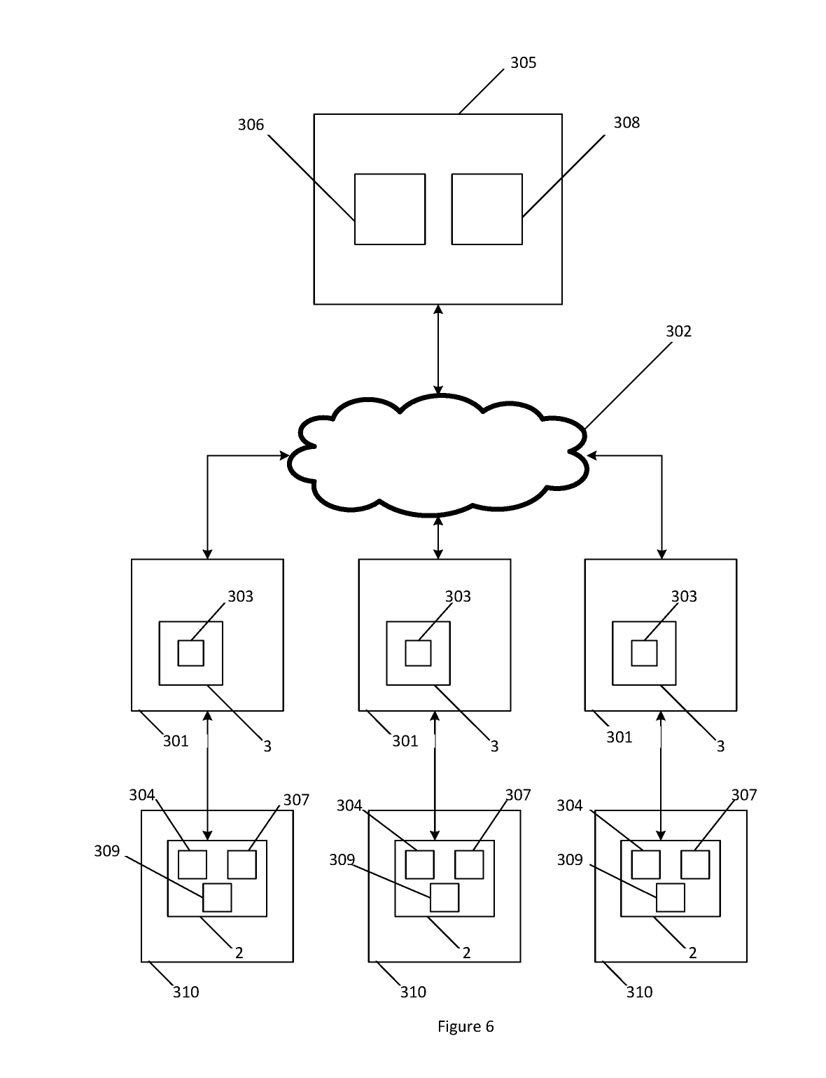

One private key 308 may correspond to several public keys 309 located at different transmitters 2. This configuration is shown in FIG. 6. This allows for the authentication system to be used for a variety of mobile devices. The charging stations 504 may be configured to suit the needs of particular devices. The authentication with each charging station may be limited to those devices with which it is suitable. For example, a user may have a smartphone, laptop and electric vehicle. However, only the vehicle may authenticate with the vehicle charger and similarly for the mobile devices, they may only authenticate with a suitable charging station. One provider may centralise their remote servers 305 for a network of charging stations 504, lowering the cost of implementation. The public key cryptography maintains a high level of security.

A public Wi-Fi access point may be made available in conjunction with the charging station so that users who do not have mobile network connectivity can still utilise wireless charging. The Wi-Fi access point does not need to be a part of the charging station, it only needs to be operational in the same space as the charging station. A single access point may allow internet access to several devices placed on several charging stations.

If the transmitter 2 were to be provided with independent network access, there would be a need to provide a secure connection such as a VPN. This would prevent the transmitter 2 from being hacked or tricked into providing access without authentication. One advantage of the authentication method is that it can be used to securely authenticate a device over an insecure channel, such as a public Wi-Fi access point.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. An inductive power receiver comprising:
a power receiving coil; and
communications circuitry operatively connected to the power receiving coil and configured:
to receive a transmitter identifier from an inductive power transmitter,
to send the transmitter identifier to a remote server,
responsive to the remote server verifying the transmitter identifier,
to receive an authentication token from the remote server, and
to send the authentication token to the transmitter,
wherein responsive to the transmitter verifying the authentication token, the power receiving coil is configured to receive wireless power from the transmitter.

2. The inductive power receiver of claim 1 wherein the communications circuitry includes an in-band or a near field communication data module configured to communicate with the inductive power transmitter

3. The inductive power receiver of claim 2 wherein the communications circuitry includes a cellular or Wi-Fi data module configured to communicate with the remote server.

4. The inductive power receiver of claim 3 wherein the inductive power transmitter is configured to not communicate directly with the remote server.

5. The inductive power receiver of claim 4 wherein the inductive power transmitter does not include a cellular data module configured to communicate with the remote server.

6. The inductive power receiver of claim 5 wherein the transmitter identifier comprises one or more of a timestamp or location information.

7. The inductive power receiver of claim 6 wherein the authentication token includes a timestamp.

8. The inductive power receiver of claim 7 wherein the authentication token is valid for a predetermined time period from when it is issued from the server.

9. The inductive power receiver of claim 8 wherein the authentication token timestamp and/or the transmitter identifier timestamp are compared against a time value from a real time clock to determine validity of the authentication token.

10. The inductive power receiver of claim 7 wherein the authentication token is a single use authentication token.

11. The inductive power receiver of claim 1 wherein the communications circuitry is further configured to send transmitter software to the transmitter, wherein the transmitter software includes updates.

12. The inductive power receiver of claim 11 wherein the communications circuitry is further configured to receive the transmitter software from the remote server.

13. A mobile device comprising:
an inductive power receiver configured to charge the mobile device;
a first communication channel configured to receive a transmitter identifier from an inductive power transmitter; and
a second communication channel configured to send the transmitter identifier to a remote server.
